(19) United States
(12) Patent Application Publication
(10) Pub. No.: US 2015/0104765 A1
(43) Pub. Date: Apr. 16, 2015

(54) ADAPTIVE GRAMMAR INSTRUCTION FOR PARALLEL STRUCTURES

(71) Applicant: Apollo Education Group, Inc., Phoenix, AZ (US)

(72) Inventors: Brendon Towle, Los Angeles, CA (US); Michael Wasson, Pittsburgh, PA (US); Annalies Vuong, Pittsburgh, PA (US); Linda Schmandt, Pittsburgh, PA (US); Jesse Nesbella, Pittsburgh, PA (US); Joanna Morey, Atlanta, GA (US)

(21) Appl. No.: 14/464,616

(22) Filed: Aug. 20, 2014

Related U.S. Application Data
(60) Provisional application No. 61/890,875, filed on Oct. 15, 2013.

(51) Int. Cl. G09B 7/04; G06F 17/28; G09B 19/00; G06F 3/0481; G06F 17/24; G06F 17/27; G06F 3/0484

(52) U.S. Cl. CPC G09B 7/04; G06F 17/274; G06F 17/28; G06F 3/04842; G06F 3/0481; G06F 17/24; G09B 19/00
USPC 434/169

(57) ABSTRACT

Techniques are described for an automated grammar teaching system that displays sentences and allows a user to identify parallel structure errors within the sentences, if any. The user may be asked to determine whether the sentences have a parallel structure error, to identify the items that should be made parallel in structure, to select items to be changed from the identified items, and to provide corrections to the selected items so that all the items form consistent parallel structures. Multiple parallel structures may be valid and accepted as correct for a given parallel structure error. To guide the user, user responses may trigger the display of remediation information, which may include reasons why the selected items are incorrect. New sentences in the teaching system may be selected based on historical data maintained for the user.

### CROSS-REFERENCE TO RELATED APPLICATIONS

### Benefit Claim

This application claims the benefit of U.S. Provisional Application No. 61/890,875, filed Oct. 15, 2013, which is hereby incorporated by reference in its entirety for all purposes as if fully set forth herein.

### FIELD OF THE INVENTION

The present invention relates to teaching natural language conventions, and, more specifically, to an adaptive grammar teaching system configured to train users on identifying and correcting parallel structure errors within natural language sentences.

### BACKGROUND

Natural languages are spoken languages (such as American English), which have grammar rules governing the composition of the natural language. There are stylistic conventions that apply to the written form of a natural language, which, unlike natural language per se, must be taught. When a person has not learned the proper stylistic conventions for written language, the student may encounter difficulty in communicating in writing, particularly in formal documents. For example, it may be particularly difficult for a person who does not understand the punctuation rules of American English to write an error-free research paper or formal letter, which limits that person's ability to communicate effectively through writing.

Grammar checkers, e.g., Grammerly.com, Thelma Thistleblossom, and grammar checkers included with document editors such as Microsoft Word, identify certain types of grammatical and punctuation errors in written documents. However, grammar and punctuation error identification/correction is not the same as teaching grammar and punctuation rules, even when the grammar checker indicates why each identified error is an error. Grammar checkers generally do not teach either prescriptive or descriptive rules of grammar, nor do grammar checkers target particular problems that users have with grammatical or stylistic rules. At times, the grammar checkers identify “errors” that are not errors at all, and rely on the user's knowledge to ultimately determine whether an error exists. Thus, grammar checkers are generally ineffective at teaching a user the conventions of formal written language.

Some English courses, e.g., in secondary and higher education, attempt to teach prescriptive grammar rules, largely using face-to-face teaching techniques, quizzes, and other activities. At times, automation is used in such traditional English courses. However, this automation generally consists of providing a student with multiple-choice questions and giving the student feedback on the student's selected answers. It can be difficult for an English teacher to identify and aid each student with the student's individual grammar or stylistic misconceptions, especially since classes tend to be large and students tend to have a wide range of skill gaps with respect to mastery of prescriptive grammar rules. At least the above mentioned deficiencies can allow students to complete English courses without learning all of the prescriptive grammar rules that they need to produce error-free communications.

Therefore, it would be beneficial to provide an automated grammar teaching system that is configured to teach prescriptive stylistic conventions targeted to the needs of students.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example network arrangement for an automated grammar teaching system that adaptively instructs a user regarding grammar rules governing parallel structures in sentences.

FIG. 2 depicts a flowchart for receiving input information from a user identifying parallel structure errors in a displayed natural language sentence.

FIG. 3A, FIG. 3B, FIG. 3C, and FIG. 3D depict a graphical user interface configured to allow a user to identify, within a displayed sentence, parallel structure errors.

FIG. 4 depicts a flowchart for receiving input information from a user identifying a correction of a parallel structure error in a displayed natural language sentence and determining whether the correction is accurate.

FIG. 5A, FIG. 5B, FIG. 5C, FIG. 5D, and FIG. 5E depict a graphical user interface configured to allow a user to identify a correction of a parallel structure error within a displayed sentence.

FIG. 6 is a block diagram of a computer system on which embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

An automated grammar teaching system delivers highly personalized, differentiated instruction to users. The automated grammar teaching system provides lessons and adaptive practice to build each student's skills for the rules of natural language grammar with respect to parallel structures. Parallel structure problems are automatically presented to students by the automated grammar teaching system, and are configured to address each student's continuous learning needs with respect to granular grammar skills relating to parallel structures.

Sentences of problems are presented to the user in a user interface. The problems may be presented as single sentences. The user may be asked to perform 3 different tasks, including 1) identifying the structures that should be parallel, 2) selecting the structures that are incorrect, 3) making the correction by typing the corrections. In various embodiments, problems may only require a subset of the above tasks to be completed.

In an embodiment, if a user incorrectly identifies a particular portion or an entirety of a sentence as having a parallel structure error, then the system displays remediation information to help the user understand why the identification is incorrect. In an embodiment, if a user provides an inaccurate correction to a parallel structure error, the system displays remediation information to explain why the correction that the user specified is inaccurate. Further, the automated grammar teaching system records, as historical data, a user's actions within the system. The system uses this historical data to identify what sentences, with what kinds of parallel structure errors, the system should provide to the user.

### Adaptive Grammar Instructions Architecture

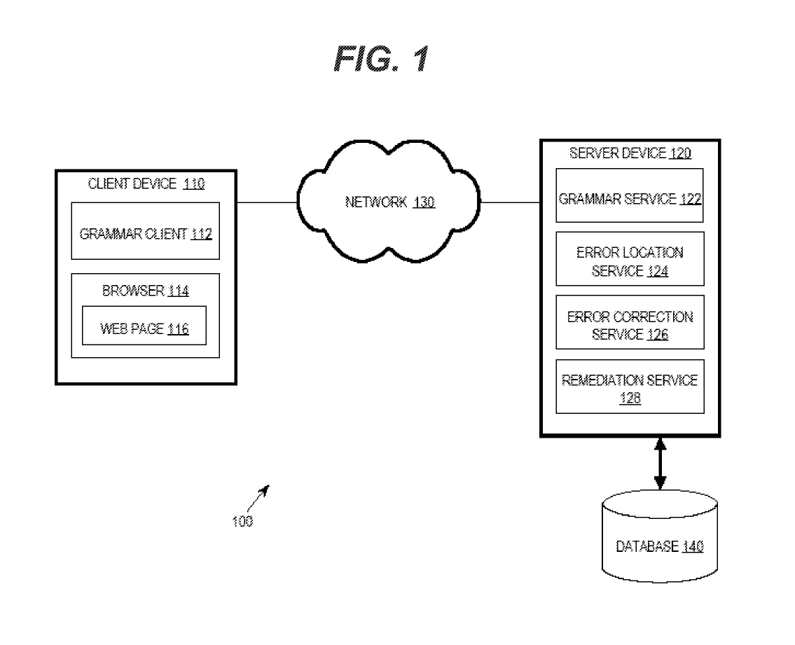

Techniques are described hereafter for adaptively instructing a user on grammar rules governing parallel structure usage in sentences. FIG. 1 is a block diagram that depicts an example network arrangement 100 for an automated grammar teaching system that adaptively instructs a user regarding grammar rules governing parallel structure usage in sentences, according to embodiments. Network arrangement 100 includes a client device 110 and a server device 120 communicatively coupled via a network 130. Server device 120 is also communicatively coupled to a database 140. Example network arrangement 100 may include other devices, including client devices, server devices, and display devices, according to embodiments. For example, one or more of the services attributed to server device 120 herein may run on other server devices that are communicatively coupled to network 130.

With respect to FIG. 1, server device 120 may correspond to server device 120 from FIG. 1.1, as described in Section 1.0 of the parent provisional application. Accordingly, additional services such as mastery tracking service 124 and hint service 126 from service device 120 of FIG. 1.1 may also be included in server device 120 of FIG. 1.

Client device 110 may be implemented by any type of computing device that is communicatively connected to network 130. Example implementations of client device 110 include, without limitation, workstations, personal computers, laptop computers, personal digital assistants (PDAs), tablet computers, cellular telephony devices such as smart phones, and any other type of computing device.

In network arrangement 100, client device 110 is configured with a grammar client 112 and a browser 114 that displays web page 116. Grammar client 112 may be implemented in any number of ways, including as a plug-in to browser 114, as an application running in connection with web page 116, as a stand-alone application running on client device 110, etc. Grammar client 112 may be implemented by one or more logical modules, and is described in further detail below. Browser 114 is configured to interpret and display web pages that are received over network 130 (e.g., web page 116), such as Hyper Text Markup Language (HTML) pages, and eXtensible Markup Language (XML) pages, etc. Client device 110 may be configured with other mechanisms, processes and functionalities, depending upon a particular implementation.

Further, client device 110 is communicatively coupled to a display device (not shown in FIG. 1), for displaying graphical user interfaces, such as graphical user interfaces of web page 116. Such a display device may be implemented by any type of device capable of displaying a graphical user interface. Example implementations of a display device include a monitor, a screen, a touch screen, a projector, a light display, a display of a tablet computer, a display of a telephony device, a television, etc.

Network 130 may be implemented with any type of medium and/or mechanism that facilitates the exchange of information between client device 110 and server device 120. Furthermore, network 130 may facilitate use of any type of communications protocol, and may be secured or unsecured, depending upon the requirements of a particular embodiment.

Server device 120 may be implemented by any type of computing device that is capable of communicating with client device 110 over network 130. In network arrangement 100, server device 120 is configured with a grammar service 122, an error location service 124, an error correction service 126, and a remediation service 128. One or more of services 122-128 may be part of a cloud computing service. Functionality attributed to one or more of services 122-128 may be performed by grammar client 112, according to embodiments. Services 122-128 may be implemented by one or more logical modules, and are described in further detail below. Server device 120 may be configured with other mechanisms, processes and functionalities, depending upon a particular implementation.

Server device 120 is communicatively coupled to database 140. Database 140 may reside in any type of storage, including volatile and non-volatile storage (e.g., random access memory (RAM), one or more hard or floppy disks, main memory, etc.), and may be implemented by multiple logical databases. The storage on which database 140 resides may be external or internal to server device 120.

Any of grammar client 112 and services 122-128 may receive and respond to Application Programming Interface (API) calls, Simple Object Access Protocol (SOAP) messages, requests via HyperText Transfer Protocol (HTTP), HyperText Transfer Protocol Secure (HTTPS), Simple Mail Transfer Protocol (SMTP), or any other kind of communication, e.g., from one of the other services 122-128 or grammar client 112. Further, any of grammar client 112 and services 122-128 may send one or more of the following over network 130 to one of the other entities: information via HTTP, HTTPS, SMTP, etc.; XML data; SOAP messages; API calls; and other communications according to embodiments.

In an embodiment, each of the processes described in connection with one or more of grammar client 112 and services 122-128 are performed automatically and may be implemented using one or more computer programs, other software elements, and/or digital logic in any of a general-purpose computer or a special-purpose computer, while performing data retrieval, transformation, and storage operations that involve interacting with and transforming the physical state of memory of the computer.

### Intelligent Tutoring System for Automatically Teaching Grammar

According to an embodiment, grammar service 122 and/or grammar client 112 is implemented as part of an intelligent tutoring system, such as the cognitive tutor described in Kenneth R. Koedinger, John R. Anderson, William H. Hadley, & Mary A. Mark Intelligent tutoring goes to school in the big city §2.2 (7th World Conference on Artificial Intelligence in Education 1995), which paper is incorporated herein by reference.

### Sentence Problems Stored at the Database

According to embodiments, a set of problem data includes a sentence and may also include one or more of:
a problem type indicating a parallel structure problem;
markup of a parallel structure problem sentence (as described in further detail below);
information that may be presented as hints;
identifying parallel structures or parallel coordinate sets in the sentence, including the location (coordinate) and contents of the structures, the appropriate fixes for each structure to make the parallel structure consistent, leading words for each structure, and unrelated structures or “fake coordinates” that nevertheless have the same grammatical type as the parallel structure;
the grammatical type or role of items in each parallel structure, for affecting grammar skills as discussed in Section 1.0 of the parent provisional application, including: an adjective by itself, an adverb by itself, a base infinitive, a base infinitive phrase, a gerund by itself, a gerund phrase using the gerund form of a verb, an infinitive form of a verb, an infinitive plus modifiers and/or objects, a noun by itself, a noun phrase, a prepositional phrase, a verb by itself, and a verb phrase that doesn't use one of the specialized forms;
grammatical roles played by various phrases in the sentence;
remediation information for incorrect answers, as necessary.

In some embodiments, some of the above metadata may not be explicitly specified by the problem writer. Further, the same set of words or phrases may be defined using multiple different parallel structures. For example, if a list of three items is presented in a problem, there could be a parallel structure where the list is consistent with the structure of the first two items, or a parallel structure where the list is consistent with the structure of the last item. These parallel structures may be automatically generated by construction code that is executed once to generate metadata within database 140.

To illustrate, database 140 may include, in connection with a particular set of problem data, metadata embedded into the following marked-up sentence:

A new study [_leadingWords]$recommends to[/_leadingWords]

[_baseInfinitivePhrase]change study locations[/_baseInfinitivePhrase],

[_gerundPhrase]getting enough sleep[/_gerundPhrase], and

[_gerundPhrase]participating in class[/_gerundPhrase] to $increaseSuccess.

The embedded metadata variables (“$recommends”, “$increaseSuccess”) facilitate creating alternate wordings for the marked-up sentence. For example, database 140 also includes the following definitions of the embedded variables:
‘recommends’:RandomChoiceGenerator(choices=[‘recommends’, ‘suggests’, ‘advocates’, ‘advises’, encourages’]),
‘increaseSucces’:RandomChoiceGenerator(choices=[‘increase the opportunity for academic success’, ‘improve the odds of succeeding in school’, ‘increase the likelihood for having a successful academic career’]),
   According to an embodiment, the variables are resolved before the sentence is stored at database 140. Thus, the problems may be written with metadata to allow multiple alternative wordings. For example, by adding additional metadata variables, different parallel structures may be substituted as alternatives, parallel structures may be placed or not placed according to random selection, different phrases may be selected at random, and elements may be rearranged into different orders within the sentence, allowing a wide range of possible problem sentences and sentence types to be generated from a small amount of metadata.

According to an embodiment, metadata for a sentence includes a tag that grammar service 122 may use for remediation information. Such metadata identifies one or more portions of a sentence that are correct. For example, a particular marked-up sentence includes the metadata tag [_infinitivePhrase/], which indicates to grammar service 122 that an infinitive phrase is located where the tag is positioned, but that it is irrelevant for any parallel structure. As described in further detail below, remediation service 128 may use such metadata to identify particular remediation information to display to a user. For example, if a user identifies the infinitivePhrase in a particular displayed sentence as part of the parallel structure, then remediation service 128 uses the tag that marks that infinitivePhrase to identify remediation text to display to the user. For example, the remediation text may indicate that the infinitivePhrase is not part of the parallel structure and that the parallel structure is elsewhere in the sentence.

### Graphical User Interface Displaying a Sentence

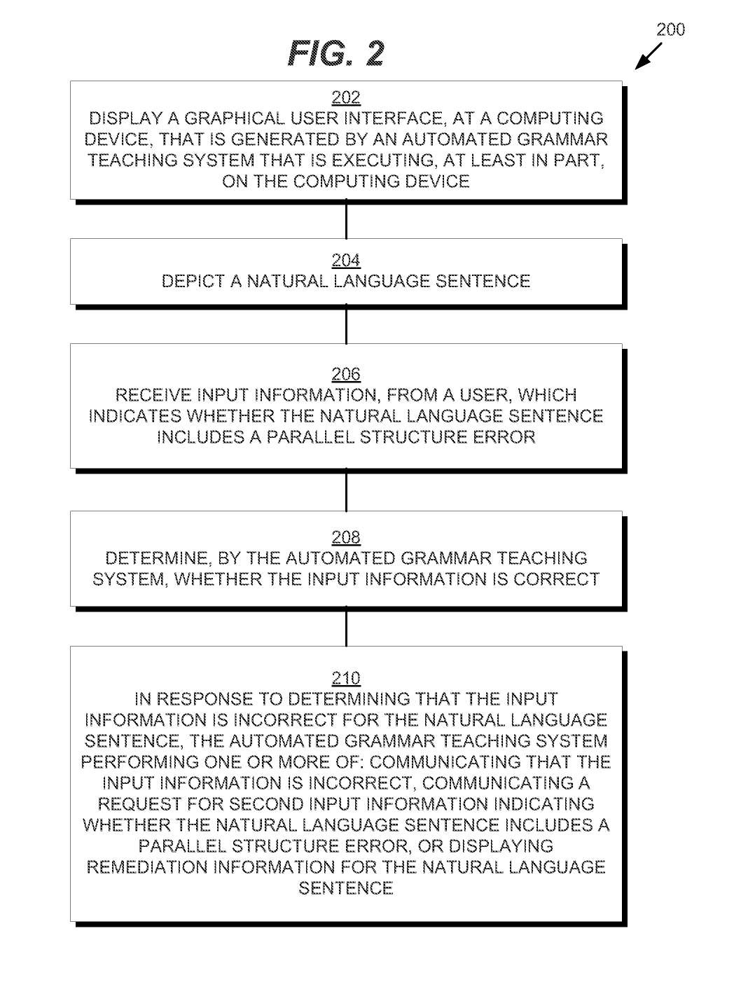

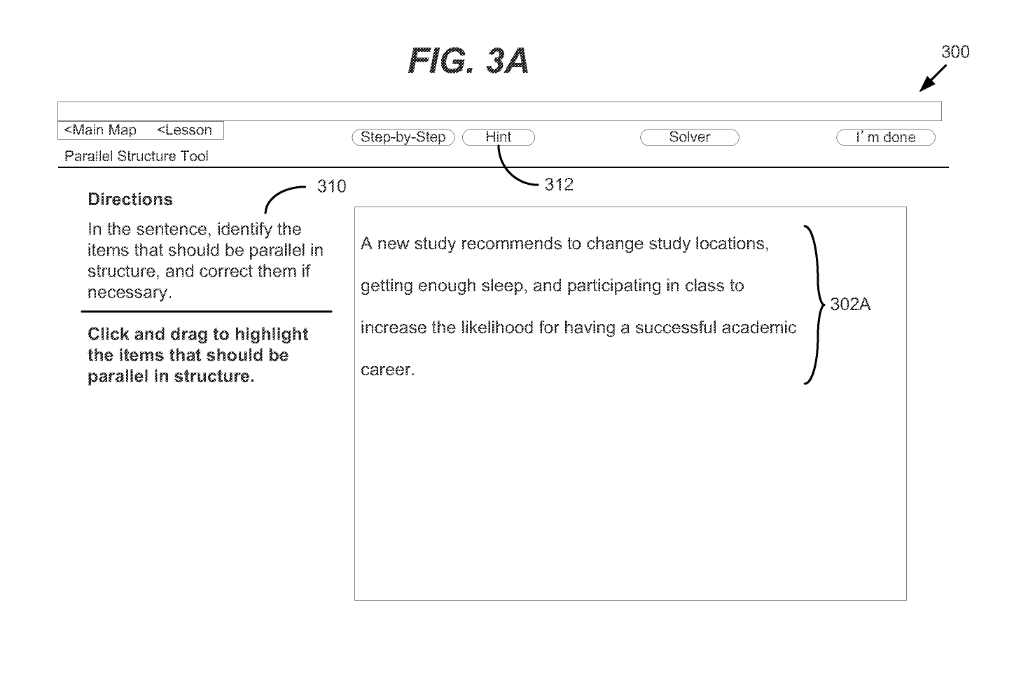

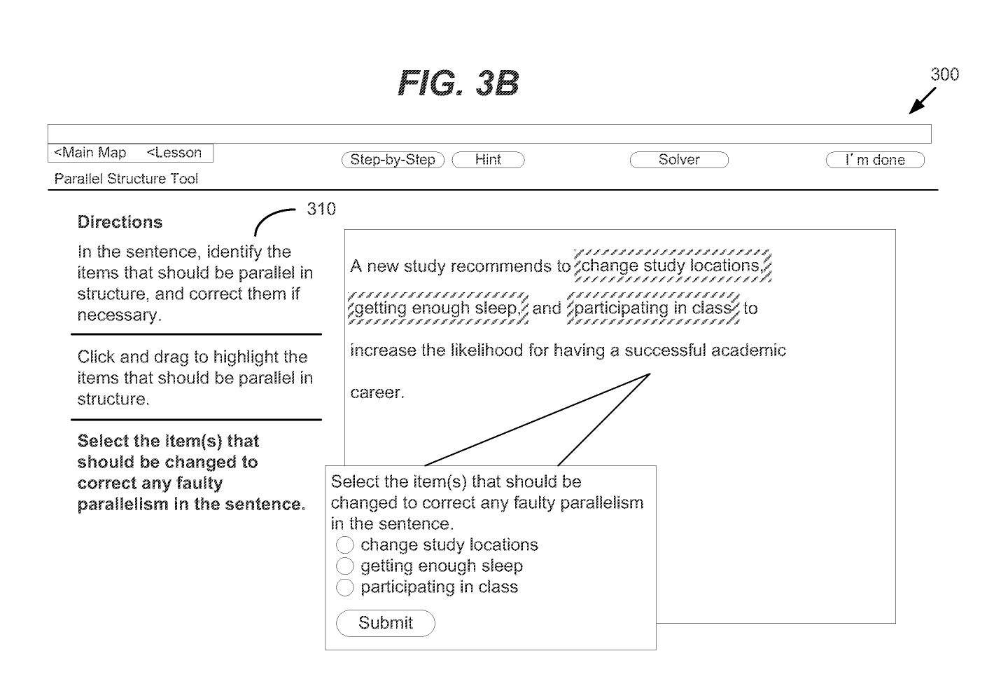

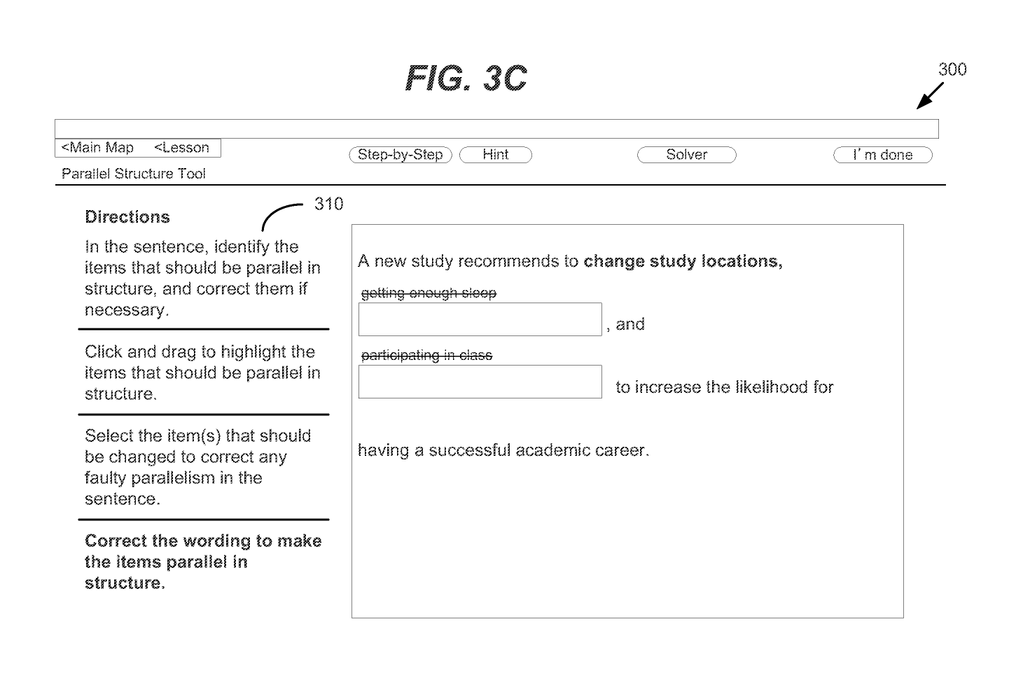

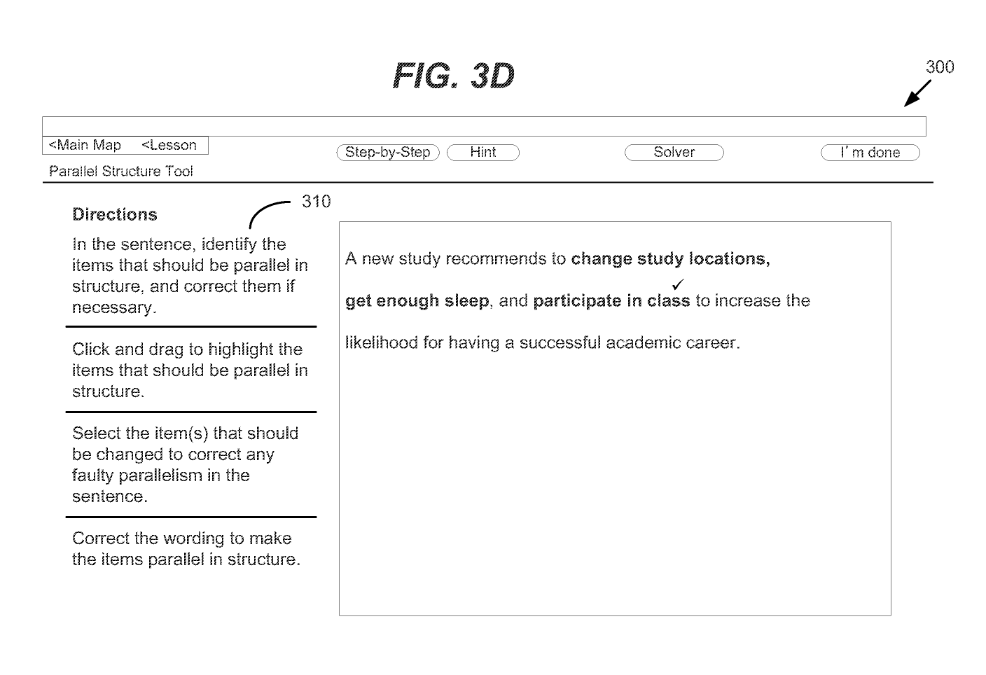

FIG. 2 depicts a flowchart 200 for receiving input information from a user identifying parallel structure errors in a displayed natural language sentence. At step 202 of flowchart 200, a graphical user interface is displayed at a computing device, which graphical user interface is generated by an automated grammar teaching system that is executing, at least in part, on the computing device. For example, in FIG. 1, web page 116 includes a graphical user interface such as GUI 300 of FIG. 3, which is generated by grammar service 122 executing on server device 120 or by grammar client 112 executing on client device 110.

Grammar service 122 sends information for GUI 300, via network 130, to grammar client 112. Grammar client 112 makes GUI 300 available to browser 114 executing on client device 110, and browser 114 displays GUI 300, i.e., in web page 116. According to another embodiment, grammar client 112 causes GUI 300 to be displayed outside of a browser, e.g., as part of a stand-alone application.

At step 204 of flowchart 200, a natural language sentence is depicted, which may include zero or more parallel structure errors. To illustrate, GUI 300 depicts natural language sentence 302A that, according to an embodiment, includes parallel structure errors. According to another embodiment, sentence 302A may or may not contain a parallel structure error, and grammar client 112 instructs users to determine whether sentence 302A includes a parallel structure error.

### Identifying Parallel Structure Errors

At step 206, input information is received, from a user, which indicates whether the natural language sentence includes a parallel structure error. For example, grammar client 112 receives information, input by the user via GUI 300 that indicates whether sentence 302A has no parallel structure error or has a parallel structure error according to the three types discussed above. A user may indicate this in various ways, such as by clicking on a yes/no dialog box, by entering a particular key stroke, etc. While flowchart 200 concerns a single parallel structure error, embodiments may also include natural language sentences that include multiple parallel structure errors. In this case, the user may correct each of the parallel structure errors one at a time.

Assuming the user has correctly identified the presence of a parallel structure error, the user may be required to further identify the locations of the parallel structures. In some embodiments, selection of the parallel structures may be made by highlighting, for example by clicking and dragging a desired selection with a pointing device. In other embodiments, the locations of the parallel structures may be given, thus requiring no user identification.

In some embodiments, the user may be further required to identify the grammatical types or roles of each of the identified parallel structures. As discussed above under the heading “SENTENCE PROBLEMS STORED AT THE DATABASE”, metadata may include the grammatical type or role for each parallel structure, such as “an adjective by itself” or “an adverb by itself”. The user may, for example by multiple-choice or drop-down menu selection, indicate the correct grammatical role of one or more of the identified parallel structures.

At step 208, the automated grammar teaching system determines whether the input information received from the user is correct. For example, moving to FIG. 3B, the user may highlight the three items indicated in GUI 300. Grammar service 122 employs error location service 124 and error correction service 126 to determine whether the user correctly identified the locations of the parallel structures. For example, error location service 124 and error correction service 126 may verify the user input as correct by referencing the metadata stored in database 140 for sentence 302A.

If the user selects the wrong location or provides the wrong correction, then the user input may be determined as incorrect. Step 208 may be carried out after the user provides input information for each problem step or task, and the user may be prevented from proceeding further until the user answers each problem step or task successfully.

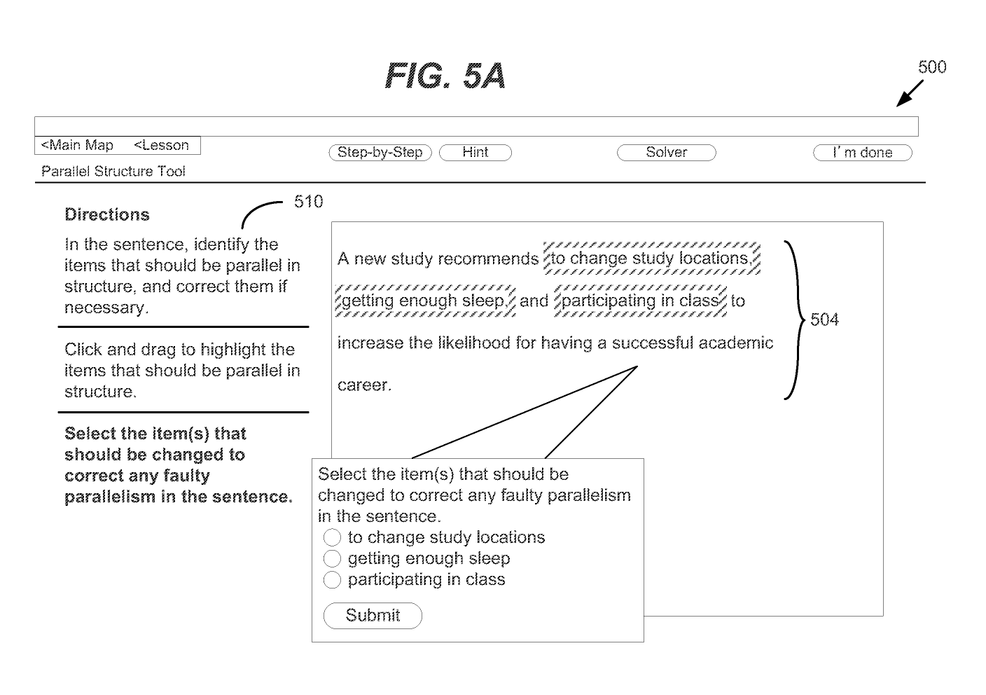

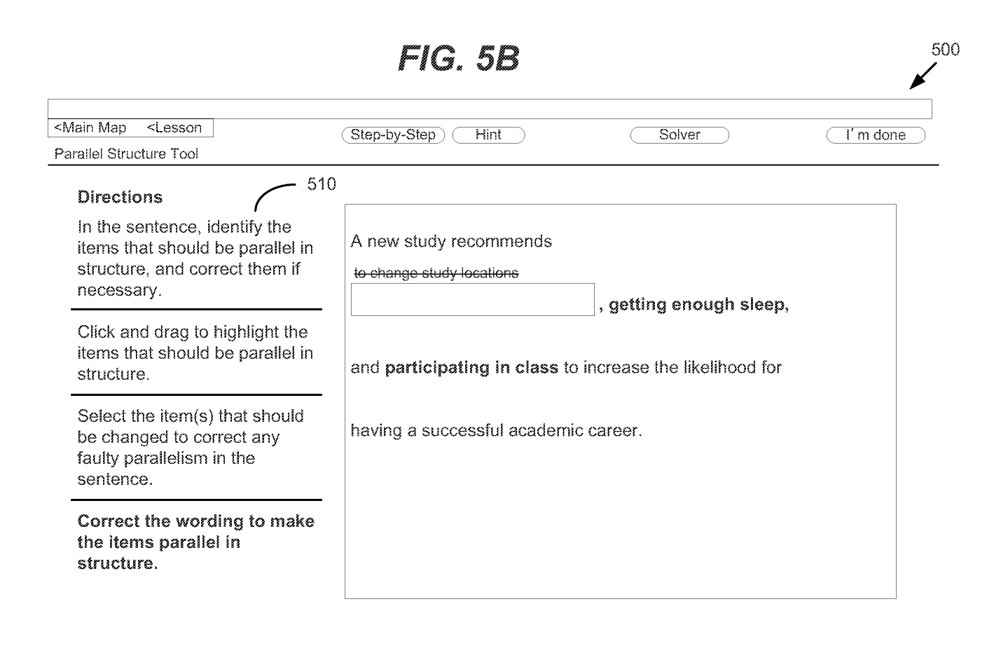

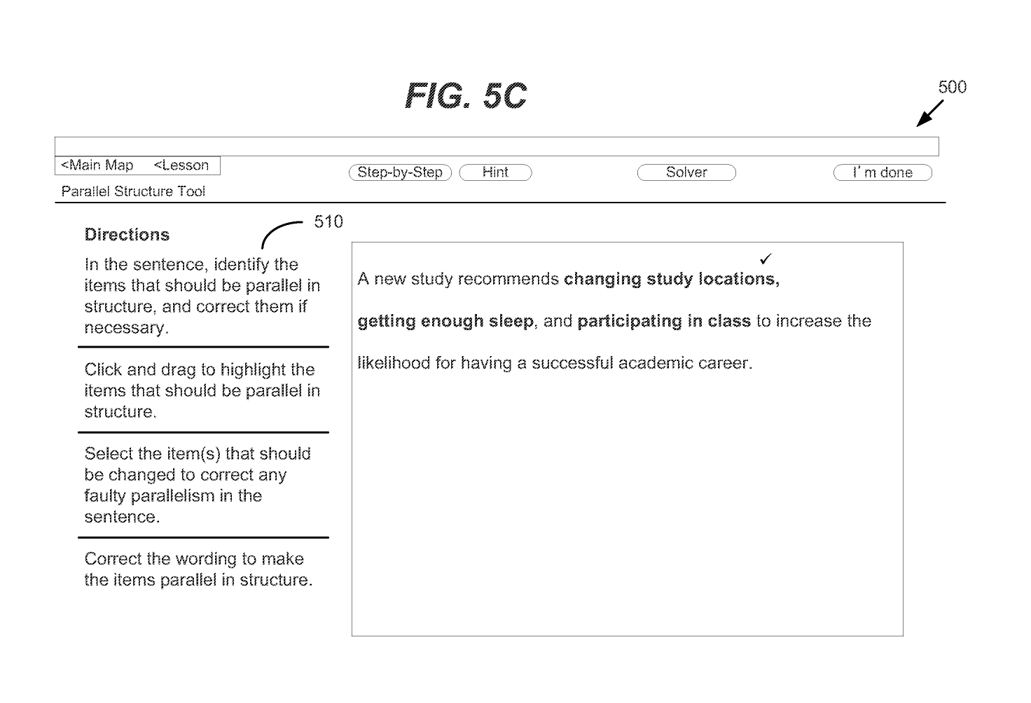

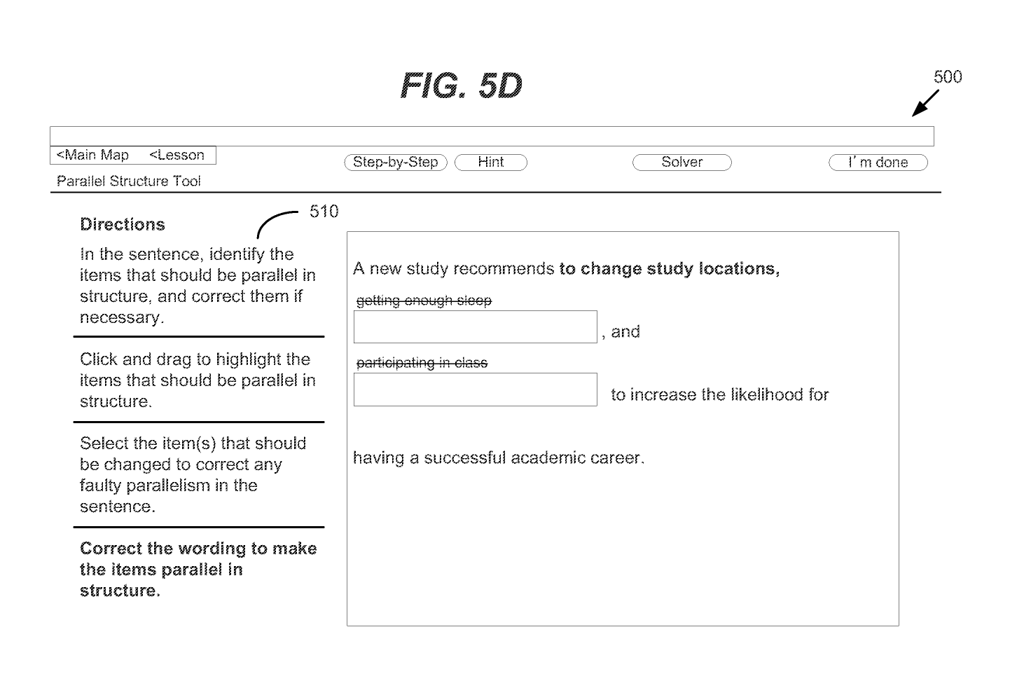

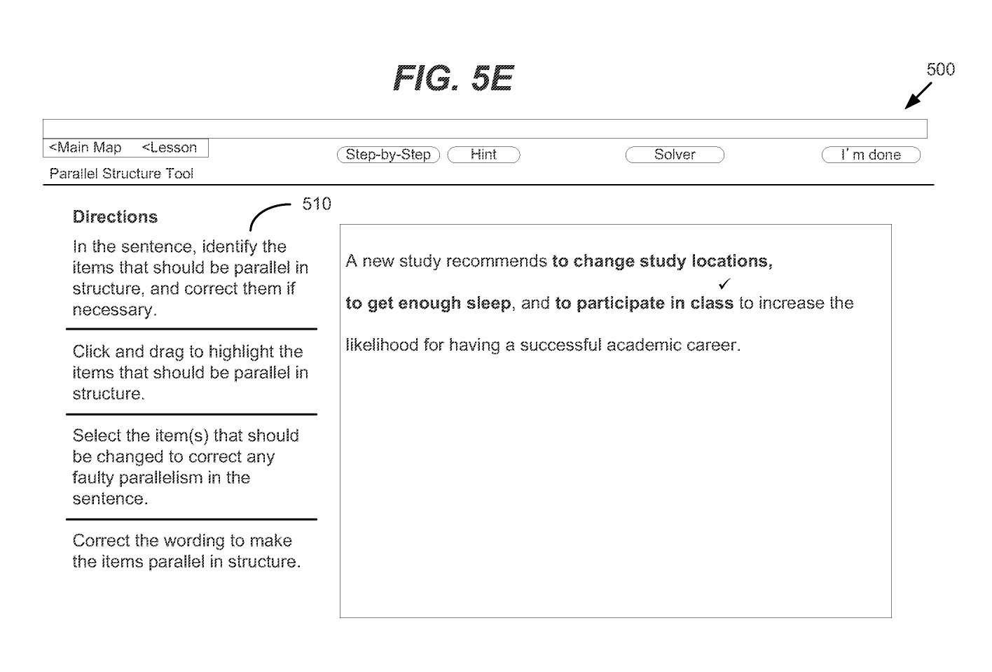

Since the parallel structures may have multiple possible solutions depending on the structure(s) used as the basis to correct the other structure(s), GUI 300 may accept several different answers as correct solutions to the problem. One solution is illustrated in FIG. 3A-3D, wherein the structures “getting enough sleep” and “participating in class” are changed to be consistent with “change study locations”. Another solution is shown in FIG. 5A-5C, wherein the structure “to change study locations” is instead changed to be consistent with “getting enough sleep” and “participating in class”. Yet another solution is shown in FIG. 5D-5E, wherein the structures “getting enough sleep” and “participating in class” are changed to be consistent with “to change study locations”, rather than “change study locations” as in FIG. 3A-3D. The processes for transitioning through FIG. 3A-3D and FIG. 5A-5E may be similar to those already discussed above in GUI 300 and GUI 500 of Sections 1.0 to 6.0 of the parent provisional application.

As discussed above, the construction code may create many possible combinations of parallel structures in the metadata stored in database 140 so that various correction possibilities can be accepted as correct answers. Since these different parallel structures present solutions or “goalposts” that may be mutually incompatible with each other, grammar service 122 may be able to detect the particular parallel structure that the user is attempting to apply, and only the corrections for that particular parallel structure may be enabled from that point forward, with corrections from all other possible parallel structures disabled. These different “goalposts” may be reflected in the metadata stored in database 140, allowing grammar service 122 to parse user inputs without conflicts even with multiple conflicting paths to different solutions.

Returning to flowchart 200 of FIG. 2, at step 210, the automated grammar teaching system performs one or more of the following actions in response to determining that the indicated input information is incorrect for the sentence:

communicating that the indicated input information is incorrect;

communicating a request for second input information; or

displaying remediation information for the incorrectly indicated sentence.

According to an embodiment, in response to the above determination of error correction service 126, grammar client 112 communicates that the indicated input information is incorrect. For example, grammar client 112 displays text that informs the user that the user has not provided the correct parallel structure for sentence 302A. As another example, grammar client 112 displays a symbol or plays a sound to indicate the incorrect selection for sentence 302A. As yet another example, grammar client 112 simply does not move on to another problem or another portion of the present problem, which communicates to the user that the user has not provided the correct parallel structure for sentence 302A.

According to another embodiment, in response to the above determination of error correction service 126, grammar client 112 communicates a request for second input information. For example, grammar client 112 displays text that requests that the user make another answer attempt. As another example, grammar client 112 highlights instructions 310 within GUI 300 (e.g., with bolded text, font color, highlight color, a displayed symbol, a displayed border, etc.).

### Hint Information

According to an embodiment, grammar client 112 displays remedial information in connection with communicating that the indicated response is incorrect. According to another embodiment, grammar client 112 displays hint information in response to detecting selection of hint button 312 (in GUI 300 of FIG. 3). Displayed hint information may be from one of various levels of hint information from the data for sentence 302A. Such levels may include (1) general instruction, (2) what concepts to think about for sentence 302A, and (3) what the correct answer is and why. Thus, as the user requests additional hints, the hints may progress from generalized rule statements to more specific instructions as applied to the specific problem at hand. The user may move forwards and backwards through the hints as desired.

Hints may also be presented in a contextually aware fashion. For example, hints may be tailored according to the specific portion or step of the problem that the user is working with. Additionally, in some embodiments, the hints may be provided proactively as a just-in-time intervention. For example, if the user begins typing a correction that is detected as incorrect, then a just-in-time tooltip may be shown, attempting to steer the user away from making the incorrect modification. In another embodiment, the remedial information may not be presented to the user until the incorrect selection has been made.

### Informal Hints

In some embodiments, less formalized hints may be given to assist the user. For example, some terms may be difficult to understand if the user is unfamiliar with formal grammar terminology. Thus, a less formalized explanation may be provided in the hints. As the user is exposed to formal grammar terminology, the hints may gradually transition to using formal terminology. Additionally, in some embodiments, an explanatory tooltip may be shown to the user when the user hovers over a particular term. In other embodiments, the information may be presented in a separate glossary that is available to the user through the use of contextual links, right-click contextual menus, search, or other means of access.

### Correcting a Parallel Structure Error

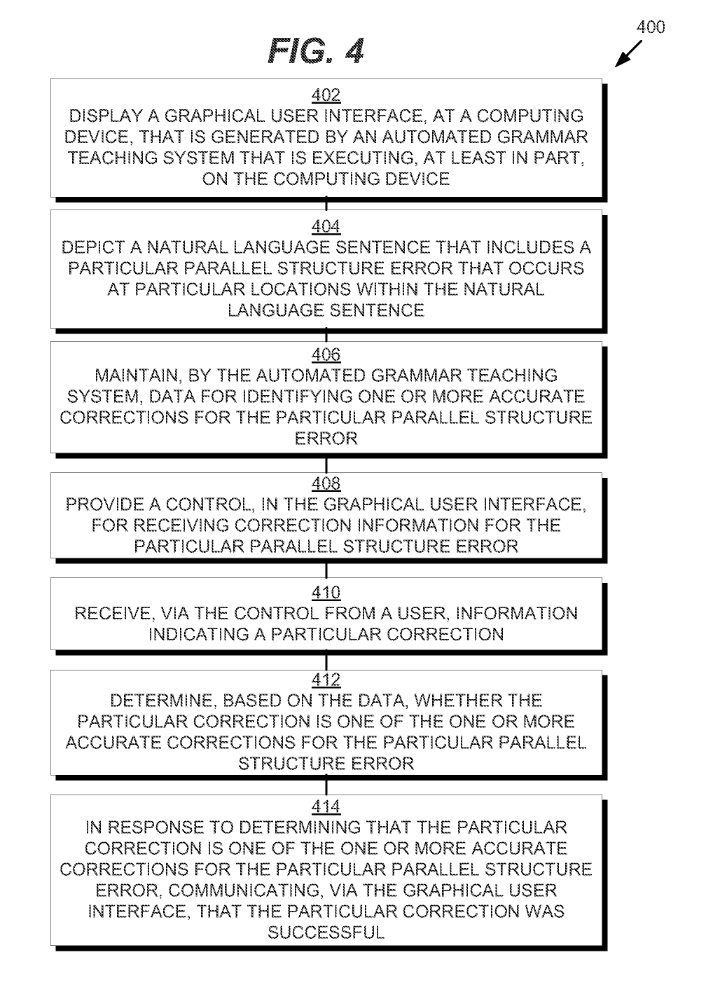

FIG. 4 depicts a flowchart 400 for receiving input information from a user identifying a correction of a parallel structure error in a displayed natural language sentence and determining whether the correction is accurate. At step 402 of flowchart 400, a graphical user interface is displayed at a computing device, which graphical user interface is generated by an automated grammar teaching system that is executing, at least in part, on the computing device. For example, web page 116 includes a GUI such as GUI 500 of FIG. 5A, which is generated by grammar service 122 executing on server device 120 or by grammar client 112 executing on client device 110.

At step 404 of flowchart 400, a natural language sentence is depicted, which includes a parallel structure error that occurs at particular locations within the natural language sentence. For example, GUI 500 depicts natural language sentence 504 that includes a parallel structure error of three items in a list that are structurally inconsistent with each other.

At step 406, the automated grammar teaching system maintains data for identifying one or more accurate corrections for the particular parallel structure error. For example, database 140 includes a set of one or more accurate correction options for the particular parallel structure error. To illustrate in the context of sentence 504, database 140 has information indicating that the following correction options are accurate for the parallel structure error:
The items “to change study locations”, “getting enough sleep”, and “participating in class” should be made consistent as parallel structures “changing study locations”, “getting enough sleep”, and “participating in class”.
The items “to change study locations”, “getting enough sleep”, and “participating in class” should be made consistent as parallel structures “to change study locations”, “to get enough sleep”, and “to participate in class”.
The items “change study locations”, “getting enough sleep”, and “participating in class” should be made consistent as parallel structures “change study locations”, “get enough sleep”, and “participate in class”.

At step 408, a control is provided, in the graphical user interface, for receiving correction information for the particular parallel structure error. For example, as shown by instructions 510, grammar client 112 presents an interface that allows the user to “click and drag to highlight the items that should be parallel in structure”. After the three items are identified as shown by the highlighting of “to change study locations”, “getting enough sleep”, and “participating in class”, a dialog box may be shown as illustrated in FIG. 5A, allowing the user to select the item(s) that should be corrected.

At step 410, information indicating a particular correction is received via the control from a user. As shown in instructions 510, the user is tasked to “select the item(s) that should be changed to correct any faulty parallelism in the sentence”. Assuming the user selects only the item “to change study locations” as needing correction, which may be checked and verified using error location service 124, GUI 500 in FIG. 5A may transition to GUI 500 in FIG. 5B.

As shown in GUI 500 and the updated instructions 510, a text box appears to allow the user to “correct the wording to make the items parallel in structure”. Accordingly, the user may type in the particular correction “changing study locations”. Grammar client 112 receives information indicating that the user has submitted a correction of “changing study locations” for the item “to change study locations” and sends the information to grammar service 122.

At step 412, it is determined, based on the data, whether the particular correction is one of the one or more accurate corrections for the particular parallel structure error. For example, grammar service 122 employs error correction service 126 to determine whether “changing study locations” replacing “to change study locations” corresponds to a valid correction when the remaining items “getting enough sleep” and “participating in class” are left as-is. Error correction service 126 thus examines the set of correction options, stored at database 140 in step 406 as discussed above, that are accurate for the particular parallel structure error.

Error correction service 126 checks each of the accurate correction options stored at database 140 in turn. In some cases, there will only be one accurate correction option. In other cases, as in this example, multiple correct answers may be available. Since the metadata in database 140 indicates that the proposed correction is acceptable, error correction service 126 determines that the particular correction is one of the accurate corrections.

Since the user typed the correction rather than merely selecting from multiple choices, it may be desirable to provide some flexibility to keep the focus on parallel structure. Accordingly, fuzzy searches or regular expressions may be supported to detect and ignore minor deviations such as spelling errors, incorrect capitalization, and excess whitespace. These deviations may be accepted as correct answers, with the corrected version shown to the user.

At step 414, in response to determining that the particular correction is one of the one or more accurate corrections for the particular parallel structure error, it is communicated, via the graphical user interface, that the particular correction was successful. In response, grammar client 112 may display text that informs the user that the user has accurately corrected the parallel structure error in sentence 504. As another example, grammar client 112 displays a symbol, such as a green checkmark, or plays a sound to indicate to the user that the user has accurately corrected the parallel structure error within sentence 504. As yet another example, grammar client 112 simply moves on to another problem or another portion of the present problem, which communicates to the user that the user has accurately corrected the parallel structure error or errors within sentence 504. Additionally, instructions 510 may be updated to reflect the successful correction. Thus, transitioning from GUI 500 of FIG. 5B to GUI 500 of FIG. 5C, it can be seen that the correction of “changing study locations” has been accepted as correct by displaying a checkmark. Since the problem is now considered solved, the user may click on the “I'm done” button to move onto the next problem.

While the above example for flowchart 400 is based on selecting “to change study locations” as the item needing correction, FIG. 5D and FIG. 5E illustrate an alternative example where the user instead selects “getting enough sleep” and “participating in class” as the items needing correction in GUI 500 of FIG. 5A. In this case, as shown in FIG. 5D, the user would enter corrections for the two selected items to make them consistent with the remaining item “to change study locations”. Moving to GUI 500 of FIG. 5E, it can be seen that the corrections “to get enough sleep” and “to participate in class” have been accepted as accurate corrections, which may use a process similar to the process described above for flowchart 400.

### Post Problem Rule Explanations

To help the user become familiar with formal grammar terminology and rules, rule explanations using formal grammar terminology may be provided after each successfully solved problem, even when informal hints are being provided. Rule explanations may be provided in the form of an on-screen character or avatar that coaches the user in a conversational style. After the user correctly answers a problem, the correct sentences may be displayed with the on-screen character commenting on the application of the rule.

### Remediation Information in Response to an Incorrect Selection

According to yet another embodiment, in response to the above determination of error correction service 126, grammar client 112 displays “remediation information” for the incorrectly indicated sentence. For example, remediation service 128 may use the metadata stored in database 140 to identify whether any corrective action submitted by the user is incorrect and to determine whether associated remediation information is available. In an embodiment, grammar client 112 presents a user with targeted remediation information about mistakes made by the user in identifying parallel structure errors. Information on why the identified sentence is incorrectly indicated educates the user on proper parallel structure usage, and therefore reinforces the user's knowledge of how to properly form sentences using parallel structures.

Remediation information includes information that explains to a user why a particular sentence is incorrectly identified as having or not having a parallel structure error. According to an embodiment, database 140 stores remediation information, including text to be displayed, for each stored sentence. According to another embodiment, database 140 stores a collection of remediation information display text indexed by unique identifiers. In this embodiment, remediation information for a particular sentence includes unique identifiers of remediation information stored in the collection.

Remediation information is created based on one or more of (a) academic literature about what students know and the mistakes that students make, (b) what subject matter experts and/or cognitive scientists know about how students learn, and (c) analysis of historical data gathered by grammar service 122. For example, grammar service 122 records, in historical data for a user, the mistakes that the user makes in identifying and correcting parallel structure errors, and what, if any, remediation information grammar client 112 was presented to the user in response to detecting the mistake. Trends in the historical data may be identified, e.g., by cognitive scientists, to determine what remediation information should be added to database 140.

Grammar client 112 displays remediation information when the user incorrectly identifies the presence or absence of a parallel structure error for any of the sentences. As discussed above, this may be determined by examining metadata within database 140 for a sentence in question. Remediation information may be shown in a pop-up window, similar to remediation information 406 in GUI component 412 of FIG. 2.4, as discussed in Section 2.0 of the parent provisional application. For example, if the user identifies the wrong parts of the sentence as the parallel structures, then remediation information may appear. This information may appear as the user is selecting, or only after the user submits the answer by clicking the “I'm done” button. The user may then proceed to retry the problem by identifying a different parallel structure. If the user is still confused, the user may request additional hints by clicking on the hint button, as described above.

According to this embodiment, database 140 contains remediation information for one or more of the following:
Identifying a fake coordinate as if it were a real coordinate;
Identifying a superset of a coordinate as a coordinate;
Identifying a subset of a coordinate as a coordinate;
Identifying a set of coordinates as those to be fixed that would leave all remaining coordinates with identical structure (matching the general rule), but would result in the overall sentence being ungrammatical.

### Tracking and Using Historical Data

Grammar service 122 identifies which problem to display to a user based, at least in part, on user information stored at database 140. According to an embodiment, the automated grammar teaching system of FIG. 2.1 is configured to maintain historical data for a user, e.g., in a user profile for the user stored at database 140. Such historical data includes one or more of: previous problems that have been presented to the user, types of previous problems that have been presented to the user, correct and incorrect answers given by the user, timing of viewing and answering presented questions, etc.

Based, at least in part, on the historical data, grammar service 122 identifies problems, to present to the user, that target concepts within the grammar rules governing sentence types with which the user has had trouble. The way that grammar service 122 interprets the data is configurable by an administrator of the system. For example, an administrator sets a rule in grammar service 122 that states that a user needs additional practice for a particular sentence type when the user misses over 50% of problems that feature the particular sentence type during the past seven days. At a certain point in time, the historical data for a particular user indicates that the user has made mistakes on a particular type of sentence 80% of the times that sentences of this type have been presented to the user in the past week. Based on this historical data and the administrator-set rule, grammar service 122 presents sentences of that type to the user at a higher rate than other types of sentences until grammar service 122 identifies that the rate of making mistakes on this type of problem is no longer over 50%.

According to embodiments:
A set of grammar skills that users are expected to master are identified, e.g., by cognitive scientists and/or subject matter experts;
Steps in individual problems are associated with particular grammar skills, e.g., by cognitive scientists and/or subject matter experts;
As the user progresses, the user's probability of mastery for each individual grammar skill is automatically calculated (according to Bayesian Knowledge Tracing), e.g., by grammar service 122; and
Problems that have associated grammar skills that the user has not mastered are automatically presented, until the user has mastered all of the grammar skills associated with available grammar problems, e.g., by grammar service 122.

In connection with sentences with parallel structure errors, grammar service 122 may track grammar skills corresponding to the item types listed above in the metadata stored in database 140.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

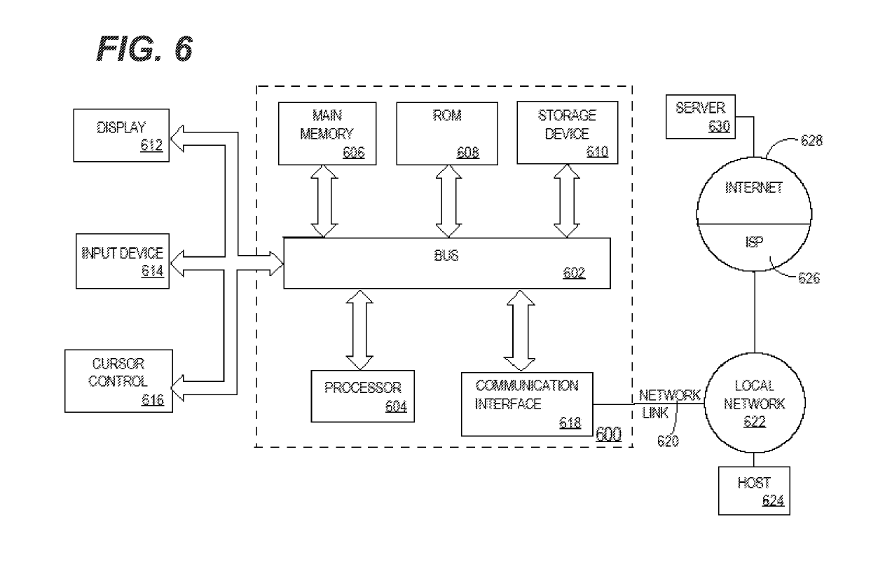

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and parallel structure selections to processor 604. Another type of user input device is cursor control 616, such as a mouse, a trackball, or cursor direction keys for communicating direction information and parallel structure selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-executed method comprising:
displaying a graphical user interface that is generated by an automated grammar teaching system that is executing, at least in part, on a computing device;
depicting a natural language sentence on the graphical user interface;
receiving input information, from a user, which indicates whether the natural language sentence includes a parallel structure error;
determining, by the automated grammar teaching system, whether the input information is correct;
in response to determining that the input information is incorrect for the natural language sentence, the automated grammar teaching system performing one or more of:
communicating that the input information is incorrect,
communicating a request for second input information indicating whether the natural language sentence includes a parallel structure error, or
displaying remediation information for the natural language sentence.

2. The method of claim 1, further comprising, prior to the receiving, communicating one or more hints for the natural language sentence.

3. The method of claim 1, wherein the communicating that the input information is incorrect further communicates one or more hints for the natural language sentence.

4. The method of claim 1, wherein the input information comprises identifying parallel structures, in the natural language sentence, that should be made consistent to correct the parallel structure error.

5. The method of claim 4, wherein the identifying of the parallel structures includes identifying locations and contents of each of the parallel structures.

6. The method of claim 4, wherein the identifying comprises highlighting the parallel structures within the graphical user interface.

7. The method of claim 4, wherein the identifying comprises identifying a grammatical type or role of each of the parallel structures.

8. The method of claim 4, wherein the remediation information comprises explaining that the identified parallel structures include a structure unrelated to the parallel structure error.

9. The method of claim 4, wherein the remediation information comprises explaining that the identified parallel structures include a structure that is a subset or a superset of a parallel structure that should be made consistent to correct the parallel structure error.

10. The method of claim 4, wherein the remediation information comprises explaining that correcting the identified parallel structures would result in the natural language sentence being ungrammatical.

11. The method of claim 1, further comprising:
in response to determining that the second input information is correct for the natural language sentence, the automated grammar teaching system performing one or more of:
providing a parallel structure rule explanation as applied for the natural language sentence,
communicating a request for third input information indicating locations of the parallel structure error; or
communicating a request for third input information indicating a grammar rule being applied for the natural language sentence.

12. The method of claim 1, further comprising:
recording, in a set of historical data for the user, information about the depicted natural language sentence and the indicated input information;
based, at least in part, on the set of historical data for the user, selecting a second natural language sentence; and
displaying a second graphical user interface, at the computing device, that depicts the second natural language sentence.

13. A computer-executed method comprising:
displaying a graphical user interface, at a computing device, that is generated by an automated grammar teaching system that is executing, at least in part, on the computing device;
depicting a natural language sentence that includes a particular parallel structure error that occurs at particular locations within the natural language sentence;
maintaining, by the automated grammar teaching system, data for identifying one or more accurate corrections for the particular parallel structure error;
providing a control, in the graphical user interface, for receiving correction information for the particular parallel structure error;
receiving, via the control from a user, information indicating a particular correction;
determining, based on the data, whether the particular correction is one of the one or more accurate corrections for the particular parallel structure error;
in response to determining that the particular correction is the one or more accurate corrections for the particular parallel structure error, communicating, via the graphical user interface, that the particular correction was successful.

14. The method of claim 13, wherein the data for identifying the one or more accurate corrections include identifying parallel structures for associated items in the natural language sentence.

15. The method of claim 13, wherein the information indicating the particular correction includes selecting items in the natural language sentence that should be made consistent with other items in the natural language sentence to correct the particular parallel structure error.

16. The method of claim 13, wherein the information indicating the particular correction includes corrections at one or more of the particular locations.

17. The method of claim 13, wherein the remediation information is based on one or more of:
academic literature about what students know about parallel structure and the mistakes students make about parallel structure;
cognitive learning models from subject matter experts and/or cognitive scientists; or
a recorded set of historical data for the user.

18. A non-transitory computer-readable medium storing one or more sequences of instructions which, when executed by one or more processors, cause performing of:
displaying a graphical user interface, at a computing device, that is generated by an automated grammar teaching system that is executing, at least in part, on the computing device;
depicting a natural language sentence that includes a particular parallel structure error that occurs at particular locations within the natural language sentence;
maintaining, by the automated grammar teaching system, data for identifying one or more accurate corrections for the particular parallel structure error;
providing a control, in the graphical user interface, for receiving correction information for the particular parallel structure error;
receiving, via the control from a user, information indicating a particular correction;
determining, based on the data, whether the particular correction is one of the one or more accurate corrections for the particular parallel structure error;
in response to determining that the particular correction is the one or more accurate corrections for the particular parallel structure error, communicating, via the graphical user interface, that the particular correction was successful.

19. The non-transitory computer-readable medium of claim 18, wherein the remediation information is based on one or more of:
academic literature about what students know about parallel structure and the mistakes students make about parallel structure;
cognitive learning models from subject matter experts and/or cognitive scientists; or
a recorded set of historical data for the user.

20. The non-transitory computer-readable medium of claim 18, wherein the data for identifying the one or more accurate corrections include identifying parallel structures for associated items in the natural language sentence.
